(19) United States
(12) Patent Application Publication
(10) Pub. No.: US 2023/0206340 A1
(43) Pub. Date: Jun. 29, 2023

(54) INSURANCE PREMIUM CALCULATION METHOD AND SYSTEM FOR VEHICLE

(71) Applicant: ERIC DAOGUANG CHEN, Oak Park, CA (US)

(72) Inventor: TERI HUEYJIUAN CHEN, OAK PARK, CA (US)

(21) Appl. No.: 17/831,438

(22) Filed: Jun. 2, 2022

Related U.S. Application Data
(60) Provisional application No. 63/265,995, filed on Dec. 23, 2021.

(51) Int. Cl. G06Q 40/08

(52) U.S. Cl. CPC G06Q 40/08

(57) ABSTRACT

An insurance premium calculation method for a vehicle is provided. The method is used to calculate a use efficiency score of the vehicle during a use period by obtaining the specifications of the vehicle, mileages, and mileages per unit energy consumption of the vehicle before and after the use period, and the insurance premium of the vehicle can be adjusted according to the usage efficiency score. By incorporating the vehicle's mileage energy consumption into the vehicle's insurance premium calculation, the impact of the vehicle's driving habits, driving environment, and mileage can be reflected by using the standardized usage efficiency score to determine the reasonable vehicle insurance premium.

### CROSS REFERENCE TO RELATED APPLICATION

The present application claims the benefit of U.S. Provisional Application Ser. No. 63/265,995 filed on Dec. 23, 2021, which is hereby incorporated by reference in its entirety.

### FIELD OF THE INVENTION

The present invention relates to a premium calculation method for vehicles, particularly to one that adjusts the premium based on the mileage of the vehicles and the energy consumed therefrom. The present invention further includes a premium calculation system for vehicles.

### BACKGROUND OF THE INVENTION

When in need of going out or transporting for various types of purpose such as working, schooling and leisure activities, some people may choose to take public transportation while most people tend to utilize their own vehicles like scooters, motorcycles and cars. In consideration of this, insurances for private-owned vehicles are getting more and more attention with the perspective of safety concerns.

Take cars for example, conventional car insurances decide the premium based on the age of the insured person, gender, marital status, types of car, purpose of use, personal credit evaluation, driving records, settlement of claims records, . . . etc. However, the conventional insurances do not factor the risks from the actual driving patterns and the environmental conditions in when deciding the premium amount.

Recently, some insurance companies started to implement the usage-based insurances (UBI). By installing telematics devices and mobile phone apps, the driving behaviours, such as over speeding, sharp turning, heavy braking and abnormal acceleration, and driving-related data, such as mileages and driving routes, are collected for evaluating the risks the vehicle may encounter and further adjusting the premium amount. However, UBI requires installation of telematics devices or mobile apps for operation which causes privacy concerns. Also, such method still does not factor the risks from the actual environmental conditions in when deciding the premium amount.

Therefore, it is an issue worth resolving to improve the problems stated and come up with a premium calculation method with more accuracy.

### SUMMARY OF THE INVENTION

An objective of the present invention is to provide a premium calculation method and system that adjusts the premium of vehicles based on the mileage and the energy consumed therefrom.

To achieve the objective mentioned above, the present invention includes the following steps:

a) retrieving a first data of a vehicle, wherein the first data includes a specifications of the vehicle, a first mileage and a first mileage with energy consumed per unit;

b) retrieving a second data of the vehicle, wherein the second data includes a second mileage and a second mileage with energy consumed per unit, and the second mileage is greater than the first mileage;

c) calculating a usage efficiency score during a period of time when the vehicle is being utilized based on the first data and the second data; and

d) adjusting a premium of the vehicle in accordance with the usage efficiency score, wherein the usage efficiency score is obtained by the following formulas:

$$UE = ( {M}_{2} - {M}_{1} ) / ( ( \frac{{M}_{2}}{{C}_{2}} ) - ( \frac{{M}_{1}}{{C}_{1}} ) )$$

$$UES = UE / {C}_{s}$$

where UE is an actual usage efficiency of the vehicle during the period of time in use; UES is the usage efficiency score; M₁ is the first mileage; M₂ is the second mileage; C₁ is the first mileage with energy consumed per unit; C₂ is the second mileage with energy consumed per unit; and Cₛ is the standard mileage with energy consumed per unit.

In an embodiment, the first mileage with energy consumed per unit can be the standard mileage with energy consumed per unit of the vehicle.

In an embodiment, the standard mileage with energy consumed per unit is an initial mileage with energy consumed per unit publicized by the manufacturer of the vehicle, or it is an average value calculated by a plurality of mileages with energy consumed per unit collected from a plurality of individual vehicles with the same specifications as the insured vehicle.

In an embodiment, the second mileage with energy consumed per unit is an mileage with energy consumed per unit calculated according to the mileage driven within the period time when the vehicle is being utilized, or it is an mileage with energy consumed per unit calculated according to a mileage greater than the default mileage resulted from utilization of the vehicle.

In an embodiment, the period of time when the vehicle is being utilized is a time gap between a first timing of the first data and a second timing of the second data.

In an embodiment, before step b) is performed, a decision is to be made by confirming if the vehicle is within the policy term or within the renewable period according to the insurance policy; then it is determined whether to proceed to step b) or not.

In an embodiment, the coverage plan of the vehicle can also be retrieved in step a) and/or step b).

In an embodiment, before proceeding to step c), the premium calculation method further includes: retrieving a standard mileage with energy consumed per unit of the vehicle corresponding to the specifications thereof.

In an embodiment, the premium of the vehicle can be further adjusted by at least one of the weighting factors which are the category, the specifications, the brand and the purpose of use of the vehicle.

The present invention further includes a premium calculation system for vehicles. The system includes a data transmission module, a storage module and a processing module. The data transmission module retrieves a first data and a second data of a vehicle, wherein the first data includes a specifications of the vehicle, a first mileage and a first mileage with energy consumed per unit, and the second data includes a second mileage and a second mileage with energy consumed per unit; the second mileage is greater than the first mileage. The storage module saves the first data, the second data, a plurality of standard mileage numbers with energy consumed per unit of vehicles and a premium calculation application program. The processing module executes the premium calculation application program, calculating a usage efficiency score within a period of time when the vehicle is being utilized based on the first data and second data and adjusting a premium of the vehicle in accordance with the usage efficiency score. The formulas of the usage efficiency score are the same as previously presented.

Therefore, the present invention is able to evaluate the usage efficiency score that reflects the driving environment of the vehicles and the driving patterns of the drivers based on the actual mileage with energy consumed per unit, and further provides an objective reference for premium adjustment. Such means is more accurate and reliable than the conventional ways. And the premium calculation method and system as disclosed in the present invention has a substantially low costs for implementation and does not require real-time monitoring or long-term tracking of the driver's driving patterns, thus reducing the possibility of violating the privacy of the consumers.

### BRIEF DESCRIPTION OF THE DRAWINGS

FIG. 1 is a block diagram of a premium calculation system according to the present invention;

FIG. 2 is a flow diagram of a premium calculation method according to the present invention; and

FIG. 3 is a schematic diagram illustrating applications of the premium calculation method under different circumstances according to the present invention.

### DETAILED DESCRIPTION OF THE PREFERRED EMBODIMENTS

In order to fully comprehend the objectives, features and efficacy of the present invention, a detailed description is described by the following substantial embodiments in conjunction with the accompanying drawings. The description is as below.

The description of unit, element and component in the present invention uses “one”, “a”, or “an”. The way mentioned above is for convenience, and for general meaning of the category of the present invention. Therefore, the description should be understood as “include one”, “at least one”, and include the singular and plural forms at the same time unless obvious meaning.

In this document, the terms “first” or “second” and similar ordinal numbers are mainly used to distinguish or refer to the same or similar elements or structures and do not necessarily imply that these elements or structures are spatially or in chronological order. In certain situations or configurations, ordinal numbers may be used interchangeably without affecting the implementation of the present invention.

The description of comprise, have, include, contain, or another similar semantics has the non-exclusive meaning. For example, an element, structure, product, or device contain multi requirements are not limited in the list of the content, but include another inherent requirement of element, structure, product or device not explicitly listed in the content. In addition, the term “or” is inclusive meaning, and not exclusive meaning.

The premium calculation method and system disclosed in the present invention apply to insurances for vehicles. The vehicles mentioned herein indicate energy-driven transportation tools such as automobile cars, motorcycles and scooters, large motor vehicles, trucks and tour buses. The energy can be fuel, gas, electricity or any of the combinations. In addition, the present invention can be utilized directly by insurance companies or provided to a business company in cooperation with the insurance industry, depending on different needs and requirements.

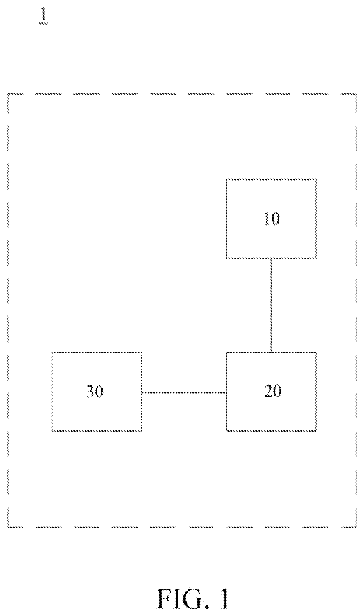

Referring to FIG. 1, a block diagram of the premium calculation system according to the present invention, the system can be a hardware, as a mainframe computer or a server, a software, as an application program, or a combination of the hardware and software as previously stated. In an embodiment, the premium calculation system 1 includes a data transmission module 10, a storage module 20 and a processing module 30.

The data transmission module 10 is for inputting or outputting the data required for premium calculation, e.g., a first data and a second data of a vehicle. The data transmission module 10 can be a hardware, a software, or a combination thereof. Such hardware can be a data transmission device, e.g., a transmission port or a transmission chip via the Ethernet or wireless networks; such software can be at least partial of an application program. But the present invention is not limited to such application. The first data and second date of the vehicle mentioned above can be provided by the consumers directly or by the insurance companies, wherein the first data includes at least the specifications of the vehicle, a first mileage and a first mileage with energy consumed per unit, and the second data includes at least a second mileage and a second mileage with energy consumed per unit.

The specifications of the vehicle are mainly relative information of the insured vehicle such as the brand, model or other hardware specifications. The first mileage is the mileage the vehicle has traveled at a first timing. The first mileage with energy consumed per unit is the mileage with energy consumer per unit of the vehicle at the first timing. The mileage with energy consumed per unit is commonly referred to as fuel economy which is defined by the mileage traveled with the energy consumed per unit; a common expression of miles-per-gallon (MPG) is a typical example. The second mileage is the mileage the vehicle has traveled at a second timing. The second mileage with energy consumed per unit is the mileage with energy consumed per unit of the vehicle at the second timing.

According to the present invention, after the first timing, the vehicle is being utilized for a period of time and then it reaches the second timing. Therefore, the second timing is later than the first timing, further resulting in the second mileage retrieved being greater than the first mileage. In terms of calculation, the second mileage with energy consumed per unit can be the mileage with energy consumed per unit correspondingly calculated by the distance traveled during a period of time when the vehicle is being utilized; or it is the mileage with energy consumed per unit correspondingly calculated by the mileage number greater than a default mileage due to recent driving of the vehicle. Herein the default mileage refers to a mileage number pre-determined in the insurance policy by the insurance companies. It can be 100 kilometers, 200 kilometers or other default numbers.

The storage module 20 saves the input or output data required for premium calculation, e.g., the first data, the second data, a plurality of standard mileages with energy consumed per unit of vehicles and a premium calculation application program. The storage module 20 can be a hardware, a software, or a combination thereof. Such hardware can be a data storage device, e.g., a memory unit or a hard drive; such software can be at least partial of an application program. But the present invention is not limited to such application. The storage module 20 can also be a data base consists of multiple mainframe computers or multiple storage units. The standard mileage with energy consumed per unit can be an initial mileage with energy consumed per unit publicized by a manufacturer of the vehicle, e.g., the mileage with energy consumer per unit according to the specifications of the vehicle when it left the factory, or it is an average value calculated by a plurality of mileages with energy consumed per unit collected from a plurality of individual vehicles with the same specifications as the insured vehicle, e.g., collecting multiple numbers of the mileage with energy consumed per unit from many identical vehicles or those have the same specifications and obtaining an average number of the mileages with energy consumed per unit by calculation.

The processing module 30 is electrically connected to the transmission module 10 and the storage module 20 for executing the premium calculation application program, calculating a usage efficiency score within a period of time when the vehicle is being utilized based on the first data and second data and adjusting a premium of the vehicle in accordance with the usage efficiency score. The processing module 30 can be a hardware, a software, or a combination thereof. Such hardware can be a processor or a control unit similar to a processor; such software can be at least partial of an application program. But the present invention is not limited to such application.

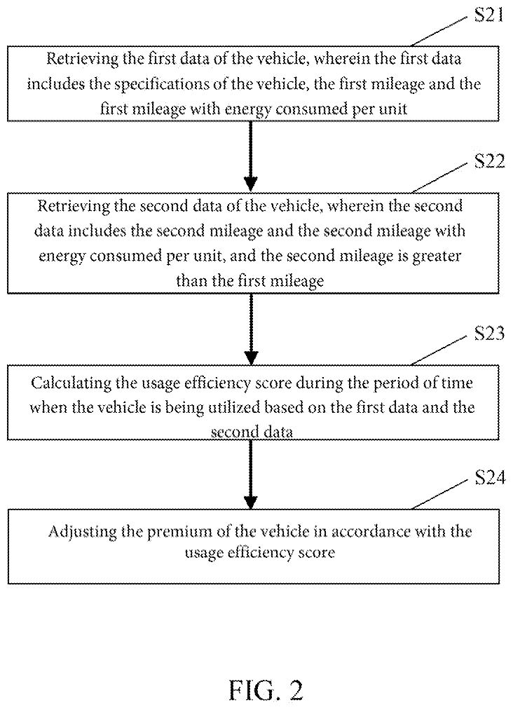

An embodiment of the premium calculation method is illustrated hereafter, in combination with the premium calculation system 1 as shown in FIG. 1. Referring to FIGS. 1 and 2 in which the latter is a flow diagram of the premium calculation method according to the present invention, in this embodiment, the premium calculation method includes the following steps.

Step S21: retrieving a first data of the vehicle, wherein the first data includes the specifications of the vehicle, the first mileage and the first mileage with energy consumed per unit.

Firstly, the premium calculation system 1 retrieves the first information of the vehicle via the data transmission module 10. The first data is the relative information of the vehicle at the first timing, wherein the first data includes at least a specifications of the vehicle, a first mileage and a first mileage with energy consumed per unit, and it can be uploaded directly to the data transmission module 10 by any consumer from a device such as smartphones or computers via the internet; or the first data can be provided by the consumers to the insurance companies and then processed and uploaded to the data transmission module 10 by the latter. After the first data is retrieved by the premium calculation system 1, it is saved in the storage module 20.

Since the first data is provided by the consumers for purchasing insurances for their vehicles, the consumers can also provide a coverage plan for their vehicles and upload it to the data transmission module 10 when providing the first data. The coverage plan may include personal information of the consumers, relative information of the vehicles, consumers' requirements of the coverage . . . , etc.

Step S22: retrieving the second data of the vehicle, wherein the second data includes the second mileage and the second mileage with energy consumed per unit, and the second mileage is greater than the first mileage.

The premium calculation system 1 retrieves the second information of the vehicle via the data transmission module 10. The second data is the relative information of the vehicle at the second timing, wherein the second data includes at least a second mileage and a second mileage with energy consumed per unit, and it can also be uploaded directly to the data transmission module 10 by any consumer or it can be provided by the consumers to the insurance companies and then processed and uploaded to the data transmission module 10 by the latter. After the second data is retrieved by the premium calculation system 1, it is saved in the storage module 20. What is noticeable is that, in the present invention, the steps S21 and S22 can be changed in order for operation. For example, the data transmission module 10 can retrieve both the first and second data at the same time, or it can retrieve the second data first, and then the first data. The order of the steps can be altered depending on different requirements or embodiments.

Since the second data is also provided by the consumers for purchasing insurances for their vehicles, the consumers can also provide another coverage plan for their vehicles and upload it to the data transmission module 10 when providing the second data. (If the consumer is providing both the first and second data at the same time, he/she can provide only one coverage plan during the process.)

In an embodiment, before step S22 is performed, the processing module 30 decides whether the vehicle is within the policy term or within the renewable period according to the insurance policy. Then it determines whether to proceed to step S22 or not. For instance, assuming a consumer has purchased an insurance for his vehicle, before the premium calculation system 1 retrieves the second data of the vehicle, the processing module 30 can determine whether it is still within the policy term or it is within a renewable period according to the insurance policy. If yes, the processing module 30 decides to perform step S22 to retrieve the second data and proceed accordingly, for instance, reducing the premium depending on the circumstances; if no, that means the previous policy term or the renewable period is overdue or it means the consumer has never purchased insurances from this particular insurance company, and the processing module 30 will decide to stop performing step S22 and proceed accordingly, for instance, increasing the premium depending on the circumstances.

Step S23: calculating the usage efficiency score during the period of time when the vehicle is being utilized based on the first data and the second data.

After steps S21 and S22, the premium calculation system 1 has executed the premium calculation application program via the processing module 30 and obtained the usage efficiency score of the vehicle during the period of utilization based on the first data and the second data. Wherein the period of time when the vehicle is being utilized is a time gap between the first timing of the first data and the second timing of the second data. For instance, the time gap can be between two purchases of the insurances for the vehicle, between when the vehicle left the factory and the first purchase of the insurance, or any other specified time gap. The usage efficiency score is obtained by the following formulas:

$$UE = ( {M}_{2} - {M}_{1} ) / ( ( \frac{{M}_{2}}{{C}_{2}} ) - ( \frac{{M}_{1}}{{C}_{1}} ) )$$

$$UES = UE / {C}_{s}$$

where UE is an actual usage efficiency of the vehicle during the period of time; UES is the usage efficiency score; M₁ is the first mileage; M₂ is the second mileage; C₁ is the first mileage with energy consumed per unit; C₂ is the second mileage with energy consumed per unit; and Cₛ is the standard mileage with energy consumed per unit.

In an embodiment of the present invention, the processing module 30 can retrieve a standard mileage with energy consumed per unit of the vehicle from the specifications thereof before step S23. Since the standard mileage with energy consumed per unit (of the vehicle is needed in the calculation of the usage efficiency score, the processing module 30 will find the standard mileage with energy consumed per unit according to the specifications of the vehicle in the first data, retrieving one that meets the specifications of the vehicle from the plurality of standard mileages with energy consumed per unit saved by the storage module 20 in advance. Thereby the accuracy of the usage efficiency score obtained from the formulas is ensured.

Step S24: adjusting the premium of the vehicle in accordance with the usage efficiency score.

After step S23, the processing module 30 can adjust the premium of the vehicle based on the usage efficiency score, combining with different conditions, so as to produce a premium amount fitting the circumstances of the vehicles. The higher the usage efficiency score is, the more discounts can be offered to the consumers; on the other hand, the lower the usage efficiency score is, the higher the premium can cost the consumers. Since the usage efficiency score is calculated based on relative parameters of the vehicles, the formulas standardize the mileage with energy consumed per unit caused by different makes, models and years of the vehicles and measure and compare the usage efficiency of all vehicles with the same fuel type consistently, so that the score can be an objective basis for premium adjustment. Therefore, the present invention can be regarded as a Usage Efficiency-Based Insurance (UEBI).

In an embodiment, other than processing the usage efficiency score, the processing module 30 can also include different conditions as weighting factors, or even be combined with a conventional premium calculation method to adjust and produce a premium amount fitting the circumstances of the vehicles. The weighting factors herein include the category, the specifications, the brand and the purpose of use of the vehicles, and at least one of the weighting factors can be included in the calculation. Also, the actual mileage driven, accidents records and violation records of the vehicles can also be regarded as the weighting factors.

In the following illustrations, there are different scenarios of how the present invention is applied. Here we have a four-wheel vehicle (e.g., a sedan) as the insured for exemplary purpose, but the present invention is also applicable in other categories of vehicles as well.

Scenario A: A consumer wants to buy an insurance for his new car. The consumer inserts his personal information and data of the vehicle via devices such as a smartphone or a computer and uploads it directly to the premium calculation system 1 of the present invention. The timing when the consumer makes the purchase and signs the deal is regarded the first timing, and the data provided for this purchase is regarded the first data of the vehicle. Since the car is brand-new, the first mileage thereof M₁ is zero and the first mileage with energy consumed per unit C₁ is the initial number publicized by the manufacturer. Theoretically there is no second data at this point; therefore the usage efficiency score of the vehicle cannot be obtained by calculation. In this case, the insurance company charges a basic premium that corresponds to the category and specifications of the vehicle and the first data is saved in the storage module 20.

Scenario B: Continued from scenario A, now the consumer wants to renew the policy term for the vehicle. Here he still inserts his personal information and data of the vehicle via devices such as a smartphone or a computer and uploads it directly to the premium calculation system 1 of the present invention, the same as previously in scenario A. The timing when he renews the policy term is regarded the second timing, and the data provided for this renewal is regarded the second data of the vehicle. The second mileage of the vehicle M₂ is the mileage driven till the second timing, and the second mileage with energy consumed per unit C₂ is the number at the second timing. Thereby, the premium calculation system 1 calculates the usage efficiency score by the processing module 30 based on the first data obtained in scenario A and the second data obtained this time. Then it adjusts the premium amount in accordance with the usage efficiency score obtained in this process.

Scenario C: A consumer wants to buy an insurance for a used car, e.g., a car already has a mileage number. The consumer inserts his personal information and data of the vehicle via devices such as a smartphone or a computer and uploads it directly to the premium calculation system 1 of the present invention. The timing when the consumer makes the purchase and signs the deal is regarded the second timing, and the data provided for this purchase is regarded the second data of the vehicle. Since there is no information on the first data, the first timing is regarded at when the vehicle was still a brand-new car and the first data is the data the vehicle holds when it was brand-new. Therefore, the first mileage thereof M₁ is zero and the first mileage with energy consumed per unit C₁ is the initial number publicized by the manufacturer. The second mileage of the vehicle M₂ is the mileage driven till the second timing, and the second mileage with energy consumed per unit C₂ is the number at the second timing. Thereby, the premium calculation system 1 calculates the usage efficiency score by the processing module 30 based on the first data and the second data; then it adjusts and produces a reasonable premium amount in accordance with the usage efficiency score obtained in this process.

Scenario D: Continued from scenario C, now the consumer wants to renew the policy term for the vehicle. Here he still inserts his personal information and data of the vehicle via devices such as a smartphone or a computer and uploads it directly to the premium calculation system 1 of the present invention, the same as previously in scenario C. The timing when he made the purchase and signed the deal is regarded the first timing, and the data provided for this purchase is regarded the first data. The timing when he renews the policy term this time is regarded the second timing, and the data provided for this renewal is regarded the second data. The first mileage M₁ herein is the second mileage M₂ in scenario C, and the first mileage with energy consumed per unit C₁ herein is the second mileage with energy consumed per unit C₂ in scenario C. The second mileage M₂ of the vehicle herein is the mileage driven till the second timing, and the second mileage with energy consumed per unit C₂ is the number at the second timing. Thereby, the premium calculation system 1 calculates the usage efficiency score by the processing module 30 based on the first data and the second data. Then it adjusts the premium amount in accordance with the usage efficiency score obtained in this process.

Therefore, whether it is the first purchase or a renewal, the premium calculation system 1 is able to perform the premium adjustment so that the consumers are charged with a reasonable payment that fits the circumstances.

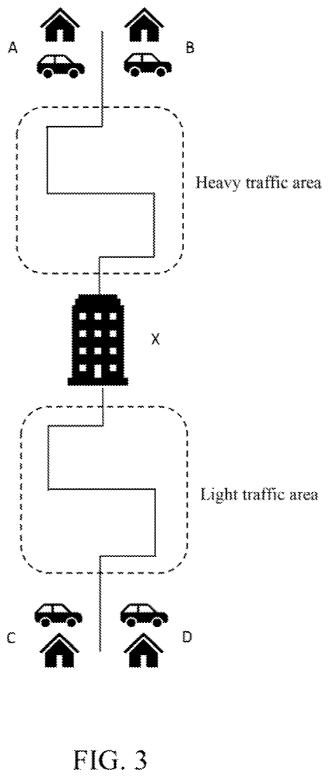

The concept of the premium calculation method is further illustrated hereafter. Please refer to FIG. 3 and Table 1. FIG. 3 illustrates applications of the premium calculation method under different circumstances and Table 1 is a comparison between these circumstances with different drivers as the consumers. As shown in FIG. 3 and Table 1, assuming there are 4 consumers—A, B, C and D—and every one of them is at the same age, has the same car and drives from their own houses to the same location X to work by the same route with the same distance. The differences are: 1. The route A and B take has substantially heavier traffic and statistically more traffic accidents, while the one C and D take is the opposite of both traffic and traffic accidents. 2. The driving patterns of A and C are better while the ones of B and D are worse.

TABLE 1

| Type of | Premium | |
|---|---|---|
| Insurances | Comparison | Description |
| Conventional | A = B = C = D | The mileage, driving patterns and driving |
| Insurance | | environments are not factored in. |
| Mileage-based | A = B = C = D | The driving patterns and driving environments |
| Insurance | | are not factored in. |
| Usage-based | (A = C) < (B = D) | The driving environments is not factored in. |
| Insurance (UBI) | | |
| UEBI | C < (A, D) < B | UES comparison between A and D: |
| | | A < D The influence of driving environment |
| | | is greater than the one of driving pattern. |
| | | A = D The influence of driving environment |
| | | is the same as the one of driving pattern. |
| | | A > D The influence of driving pattern is |
| | | greater than the one of driving environment |

In view of the conventional insurances, the age and the category of the vehicle are the only two factors taken into consideration, without including the mileage, driving pattern and the driving environment. Such concept results in that all four consumers are rated at the same risk level, thus paying the same amount of premium. This is seriously out of balance for premium estimation and does not reflect the real risks in driving.

In view of the mileage-based insurances, the mileage is included for consideration; however, under the conditions we have set earlier, the driving distance of all four consumers are the same. Without including the driving pattern and the driving environment as the factors, these consumers are still rated at the same risk level, thus they still pay the same amount of premium. It is still out of balance seriously for premium estimation and cannot reflect the real risks in driving either.

In view of the common usage-based insurances (UBI), it further includes the mileage as well as the driving pattern for consideration. Under the conditions we have set, A and C are rated at the same risk level for their good driving patterns and therefore pay the same amount of premium; while B and D are rated at a different risk level for their bad driving patterns and therefore pay the same amount of premium which is higher than the amount of A's and C's. However, such method still excludes the influences of driving environment, thus still cannot truly reflect the risks in driving.

In view of the present invention (aka UEBI), the mileage, driving pattern and the driving environment are all taken into consideration. Under the conditions we have set, C has a good driving pattern and drives on a route with substantially less traffic and statistically less accidents, resulting in a relatively higher mileage with energy consumed per unit for his vehicle and the highest usage efficiency score from the calculation method of the present invention. Consequently, C is rated at the lowest risk level and pays relatively the least amount of the premium. B has a bad driving pattern and drives on a route with substantially heavier traffic and statistically more accidents, resulting in a relatively lower mileage with energy consumed per unit for his vehicle and the lowest usage efficiency score from the calculation method of the present invention. Consequently, B is rated at the highest risk level and pays relatively the highest amount of the premium.

As for the other two consumers, A has a good driving pattern but still drives on the route with heavier traffic and more accidents and D has a bad driving pattern but drives on the route with less traffic and less accidents. The mileage with energy consumed per unit of these two consumers will be a little different due to their different driving patterns and driving environments, but they are better than B and worse than C. In other words, the usage efficiency score of the vehicles obtained by the premium calculation method varies due to the influences made by driving patterns and driving environments on the mileage with energy consumed per unit. As a result, the premium amounts A and D pay will still be different based on the actual mileage with energy consumed per unit thereof. Obviously, the premium calculation method of the present invention factors the mileage with energy consumed per unit in when calculating the usage efficiency score and therefore reflects the most truly risks in driving.

Table 2 in the following is an exemplary illustration of how the usage efficiency score and the mileage of the vehicles correlate with the premium adjustment. As shown in Table 2, after the usage efficiency score is obtained by the premium calculation method, the premium can be adjusted based on the score and the mileage. As stated previously, the higher the score is, the less risks the vehicle may encounter, and vice versa. On the other hand, the higher the mileage number is, the more risks the vehicle may encounter, and vice versa. Therefore, for those with higher usage efficiency score and/or lower mileage number, the premium amount is lower; for those with lower usage efficiency score and/or higher mileage number, the premium amount is higher. With this concept, the premium calculation method of the present invention encourages the consumers to cultivate good driving patterns and reduce unnecessary use of the vehicles by charging a lower premium, further contributing to energy saving and carbon reduction.

TABLE 2

| | Actual mileages driven (km) during policy period | | | |
|---|---|---|---|---|
| UES | <5K | 5K-7.5K | 7.5K-12K | >12K |
| ≥100 | −30% | −25% | −15% | −10% |
| 0.90-1.00 | −25% | −15% | −5% | 0% |
| 0.75-0.90 | −15% | −10% | 0% | +10% |
| <0.75 | −10% | −5% | +10% | +30% |

To sum up, the present invention—the premium calculation system 1 and method—is able to obtain the usage efficiency score during the policy period simply from the mileages and the mileages with energy consumed per unit, making it more objective, fairer and more accurate to reflect the risks in driving and to further adjust the premium amount reasonably. Plus, it is also easy for the consumers to comprehend. On the other hand, it does not require any extra equipment for the vehicles or monitoring the driving behaviours. This reduces the costs as well as resources consumptions and guarantees the privacy for the consumers. In addition, the present invention can be either solely utilized or combined with current mechanism, thereby providing a diversity of services in the industry.

The present invention is disclosed by the preferred embodiment in the aforementioned description; however, it is contemplated for one skilled at the art that the embodiments are applied only for an illustration of the present invention rather than are interpreted as a limitation for the scope of the present invention. It should be noted that the various substantial alternation or replacement equivalent to these embodiments shall be considered as being covered within the scope of the present invention. Therefore, the protection scope of the present invention shall be defined by the claims.

What is claimed is:

1. A premium calculation method for a vehicle comprising:
a) retrieving a first data of said vehicle, wherein said first data includes a specifications of said vehicle, a first mileage and a first mileage with energy consumed per unit;
b) retrieving a second data of said vehicle, wherein said second data includes a second mileage and a second mileage with energy consumed per unit, and the second mileage is greater than the first mileage;
c) calculating a usage efficiency score during a period of time when said vehicle is being utilized based on the first data and the second data; and
d) adjusting a premium of said vehicle in accordance with said usage efficiency score, where in the usage efficiency score is obtained by following formulas:
$$UE = ( {M}_{2} - {M}_{1} ) / ( ( \frac{{M}_{2}}{{C}_{2}} ) - ( \frac{{M}_{1}}{{C}_{1}} ) )$$
$$UES = UE / {C}_{s}$$
where UE is an actual usage efficiency of said vehicle during the period of time; UES is the usage efficiency score; M₁ is the first mileage; M₂ is the second mileage; C₁ is the first mileage with energy consumed per unit; C₂ is the second mileage with energy consumed per unit; and Cₛ is the standard mileage with energy consumed per unit.

2. The premium calculation method defined in claim 1, wherein the first mileage with energy consumed per unit can be the standard mileage with energy consumed per unit of the vehicle.

3. The premium calculation method defined in claim 2, wherein the standard mileage with energy consumed per unit is an initial mileage with energy consumed per unit publicized by a manufacturer of the vehicle, or is an average value calculated by a plurality of mileage numbers with energy consumed per unit collected from a plurality of individual vehicles with the same specifications as said vehicle.

4. The premium calculation method defined in claim 1, wherein the second mileage with energy consumed per unit is an mileage with energy consumed per unit calculated according to a mileage driven within the period time of when the vehicle is being utilized, or is an mileage with energy consumed per unit calculated according to a mileage greater than a default mileage of said vehicle resulted from utilization thereof.

5. The premium calculation method defined in claim 1, wherein the period of time when the vehicle is being utilized is a time gap between a first timing of the first data and a second timing of the second data.

6. The premium calculation method defined in claim 5, wherein a decision is made before step b) is performed by confirming the vehicle is within a policy term thereof or within a renewable period according to the insurance policy, in order to determine whether to proceed to step b) or not.

7. The premium calculation method defined in claim 5, wherein a coverage plan of the vehicle can also be retrieved in step a) and/or step b).

8. The premium calculation method defined in claim 1, wherein the method further includes retrieving a standard mileage with energy consumed per unit of the vehicle corresponding to the specifications thereof, before proceeding to step c).

9. The premium calculation method defined in claim 1, wherein at least one weighting factor can be included in step d) to obtain the usage efficiency score for premium adjustment, said weighting factor including category, specifications, brand and purpose of use of the vehicle.

10. A premium calculation system performed with the premium calculation method defined in claim 1, comprising:
a data transmission module for retrieving a first data and a second data of a vehicle, wherein the first data includes a specifications of said vehicle, a first mileage and a first mileage with energy consumed per unit, and the second data includes a second mileage and a second mileage with energy consumed per unit, the second mileage being greater than the first mileage;
a storage module for saving the first data, the second data, a plurality of standard mileages with energy consumed per unit of vehicles and a premium calculation application program; and
a processing module for executing said premium calculation application program, calculating a usage efficiency score within a period of time when said vehicle is being utilized based on the first data and second data and adjusting a premium of said vehicle in accordance with said usage efficiency score.
